(19) United States
(12) Patent Application Publication
(10) Pub. No.: US 2026/0112721 A1
(43) Pub. Date: Apr. 23, 2026

(54) DEVICE FOR COOLING BATTERY SYSTEM OF VEHICLE

(71) Applicants: Hyundai Motor Company, Seoul (KR); Kia Corporation, Seoul (KR)

(72) Inventor: Youn Seonung, Hwaseong-si (KR)

(21) Appl. No.: 19/015,952

(22) Filed: Jan. 10, 2025

(30) Foreign Application Priority Data
Oct. 18, 2024 (KR) 10-2024-0142814

(51) Int. Cl. H01M 10/613; H01M 10/625; H01M 10/6563

(52) U.S. Cl. CPC H01M 10/613; H01M 10/625; H01M 10/6563; H01M 2220/20

(57) ABSTRACT

A device for cooling a battery system of a vehicle can include an inlet into which air is introduced, a circulation duct through which air introduced into the inlet flows to a predetermined or selected passage so that the battery system and the air exchange heat with each other, an outlet through which air having passed through the circulation duct is discharged via an outlet space defined in the outlet, and a blower fan causing air to flow therethrough. The outlet can include a connection passage as an entrance to allow air having passed through the circulation duct to enter the outlet space, a main discharge port as a first exit to discharge air from the outlet space to the outside of the vehicle body, and a branch discharge port as a second exit to discharge air from the outlet space to an interior space of the vehicle body.

### CROSS-REFERENCE TO RELATED APPLICATIONS

This application claims the priority and benefit of Korean Patent Application No. 10-2024-0142814, filed on Oct. 18, 2024, which application is hereby incorporated herein by reference in its entirety.

### TECHNICAL FIELD

The present disclosure relates to a device for cooling a battery system of a vehicle.

### BACKGROUND

There is increasing demand for environmentally-friendly transportation means such as hybrid electric vehicles and electric vehicles.

These vehicles are powered by electric energy stored in a battery system.

Although internal combustion engines are replaced by motors using electric energy to solve environmental pollution and resource depletion, there are still many problems to be solved.

Electric energy is stored in a battery system formed by multiple battery cells. These battery cells are densely disposed in a limited space, and thus heat released from the battery cells may cause overheating of the battery system.

Overheating of the battery system may lead to deterioration in performance thereof and reduction in lifespan thereof.

To prevent this, a separate cooling device is mounted in a battery system of a hybrid electric vehicle or an electric vehicle.

The battery system should accommodate as many battery cells as possible within a given volume and weight, and the internal temperature thereof should be efficiently controlled.

A conventional air-cooling type battery cooling device circulates air inside the vehicle to cool the battery to block introduction of foreign substances from the outside.

However, vibration and noise of a blower fan for air circulation degrade ride comfort. Further, airflow noise and vibration occur due to bent portions of a cooling air circulation passage or portions of the passage at which the area thereof changes sharply.

Therefore, there is a need for technology capable of solving the above problems.

### SUMMARY

The present disclosure relates to a device for cooling a battery system of a vehicle, and more particularly to a battery system cooling device capable of discharging a portion of cooling air to the outside of a vehicle and reducing flow resistance of discharged air and circulating air, thereby reducing noise and vibration.

An embodiment of the present disclosure can solve a problem that noise and vibration occur in portions at which an air circulation passage for cooling of a battery of a vehicle is bent at a large angle or the cross-sectional area of the air circulation passage changes sharply.

An embodiment of the present disclosure can solve a problem that flow resistance of cooling air is high and cooling efficiency is low due to the complicated structure of an air circulation passage for cooling of a battery of a vehicle.

An embodiment of the present disclosure can reduce vibration and noise that can occur when the output of a blower fan is increased to forcibly circulate air inside a vehicle along a predetermined passage.

The advantages of an embodiment of the present disclosure are not necessarily limited to those mentioned above, and other advantages not mentioned herein can be understood by those skilled in the art from the following description.

A device for cooling a battery system of a vehicle according to an embodiment of the present disclosure can include an inlet into which air is introduced, a circulation duct through which air introduced into the inlet flows to a predetermined passage so that the battery system and the air exchange heat with each other, an outlet through which air having passed through the circulation duct is discharged via an outlet space defined in the outlet, and a blower fan causing air to flow along the inlet, the circulation duct, and the outlet. The outlet can include a connection passage as an entrance to allow air having passed through the circulation duct to enter the outlet space, a main discharge port as an exit to discharge air in the outlet space to the outside of the vehicle body, and a branch discharge port as an exit to discharge air in the outlet space to an interior space of the vehicle body.

A device for cooling a battery system of a vehicle according to an embodiment of the present disclosure may include a heat exchange system configured to cool air introduced into the inlet to a predetermined or selected temperature.

In a device for cooling a battery system of a vehicle according to an embodiment of the present disclosure, the inlet may receive air from the interior space of the vehicle body.

In a device for cooling a battery system of a vehicle according to an embodiment of the present disclosure, the outlet may be coupled to an upper side of a vehicle body floor to be provided on a bottom surface of the interior space of the vehicle body.

In a device for cooling a battery system of a vehicle according to an embodiment of the present disclosure, the main discharge port may include a main discharge passage passing through the vehicle body floor in a transverse direction to form a passage connected from the outlet space to the outside of the vehicle body.

In a device for cooling a battery system of a vehicle according to an embodiment of the present disclosure, the branch discharge port may include at least two branch discharge ports to discharge air in the outlet space to the interior space of the vehicle body.

In a device for cooling a battery system of a vehicle according to an embodiment of the present disclosure, the main discharge port may be formed closer to the connection passage than the branch discharge port.

In a device for cooling a battery system of a vehicle according to an embodiment of the present disclosure, the cross-sectional area of a passage interconnecting the main discharge port and the outlet space may be larger than the cross-sectional area of a passage interconnecting the branch discharge port and the outlet space.

In a device for cooling a battery system of a vehicle according to an embodiment of the present disclosure, the outlet may include at least one flow guide provided in the outlet space to adjust the flow direction of air.

In a device for cooling a battery system of a vehicle according to an embodiment of the present disclosure, the at least one flow guide may include a leading edge as a leading end portion facing the connection passage, the leading edge being formed as a curved surface, a trailing edge having a thickness gradually decreasing in a direction opposite the leading edge, and a pair of guide surfaces interconnecting the leading edge and the trailing edge, the pair of guide surfaces being formed as streamlined curved surfaces.

### BRIEF DESCRIPTION OF THE DRAWINGS

The above and other features and advantages of an embodiment of the present disclosure can be more clearly understood from the following detailed description taken in conjunction with the accompanying drawings, in which:

FIG. 1 is a view schematically showing a device for cooling a battery system of a vehicle according to an embodiment of the present disclosure;

FIG. 2 is a block diagram showing main components of a device for cooling a battery system of a vehicle according to an embodiment of the present disclosure;

FIGS. 3 and 4 are views showing an interior space of a vehicle in which a device for cooling a battery system of a vehicle according to an embodiment of the present disclosure is mounted;

FIG. 5 is a cross-sectional view of a device for cooling a battery system of a vehicle according to an embodiment of the present disclosure; and

FIG. 6 is a longitudinal-sectional view of a device for cooling a battery system of a vehicle according to an embodiment of the present disclosure.

### DETAILED DESCRIPTION OF ILLUSTRATIVE EMBODIMENTS

Hereinafter, example embodiments of the present disclosure will be described in detail with reference to the accompanying drawings.

In the following description of example embodiments disclosed in the present specification, a detailed description of known functions and configurations incorporated herein can be omitted when the same may make the subject matter of the example embodiments disclosed in the present specification rather unclear. The accompanying drawings are provided for a better understanding of the example embodiments disclosed in the present specification and are not intended to necessarily limit the technical ideas disclosed in the present specification.

It can be understood that when a component is referred to as being “connected to” or “coupled to” another component, it may be directly connected to or coupled to the other component, or intervening components may be present. As used herein, the singular forms “a”, “an”, and “the” can be intended to comprise the plural forms as well, unless the context clearly indicates otherwise.

It can be understood that the terms “comprise”, “include”, and “have”, when used herein, specify the presence of stated features, integers, steps, operations, elements, components, or combinations thereof, but do not preclude the presence or addition of one or more other features, integers, steps, operations, elements, components, or combinations thereof.

The first direction X, the second direction Y, and the third direction Z described herein can be used to describe a three-dimensional shape, and can refer to respective dimensions and directions thereof in a three-dimensional coordinate system.

Thus, the first direction X, the second direction Y, and the third direction Z may be indicated by arrows intersecting each other perpendicularly at one point in space.

An embodiment of the present disclosure relates to a device 200 for cooling a battery system 100 of a vehicle 1. The device 200 for cooling the battery system 100 of the vehicle 1 according to an embodiment of the present disclosure can appropriately maintain the temperature of the battery system 100, thereby improving the performance of the battery and prolonging the lifespan of the battery.

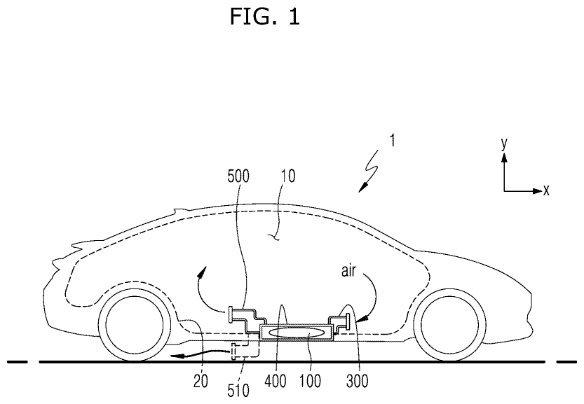

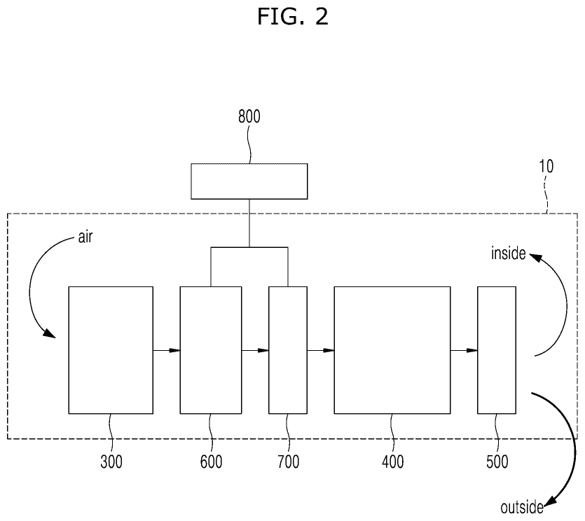

FIG. 1 is a view schematically showing a device 200 for cooling a battery system 100 of a vehicle 1 according to an embodiment of the present disclosure. FIG. 2 is a block diagram showing main components of the cooling device 200, according to an embodiment of the present disclosure.

As shown in FIGS. 1 and 2, a hybrid electric vehicle (HEV) or an electric vehicle 1 can be equipped with the battery system 100 to store electric energy.

The battery system 100 can be composed of a plurality of battery cells 110. The plurality of battery cells 110 can be protected by a battery housing 120.

The temperature of the battery system 100 may rise during operation thereof. The temperature of the entirety or part of the battery system 100 may change.

If the temperature of the battery system 100 increases, efficiency with which the battery system 100 stores and supplies electric energy can be reduced, and the lifespan of the battery cells 110 can be shortened.

The device 200 for cooling the battery system 100 of the vehicle 1 according to an embodiment of the present disclosure may be an air-cooling type cooling device for cooling the battery system 100 of the vehicle 1 to prevent increase in temperature thereof.

The cooling device 200 according to an embodiment of the present disclosure can include an inlet 300, a circulation duct 400, an outlet 500, a blower fan 600, and a controller 800, any of, any combination of, or all of which may be in plural or may include plural components thereof.

The inlet 300 can be an entrance through which air is introduced, and can be connected to an interior space 10 of the vehicle 1.

The inlet 300 can suction inside air and supply the suctioned inside air to the circulation duct 400. The inlet 300 may have an inlet space defined therein as a space having a predetermined size.

The inlet 300 can include an inside air introduction port and an inside air passage to guide inside air to the inlet space.

The entirety or part of the battery system 100 may be accommodated in the circulation duct 400. In an embodiment of the present disclosure, the battery system 100 can be disposed in the circulation duct 400. The circulation duct 400 can form an air flow passage connecting the inside of the battery housing 120 to the outside, thereby providing a passage through which cooling air can flow.

That is, the inside air in the interior space 10 of the vehicle 1 can be introduced into the circulation duct 400 through the inlet 300, exchanges heat with the battery system 100 while flowing along the passage formed in the circulation duct 400, and then can be discharged to the outlet 500.

The outlet 500 can include an outlet space 502 as a space defined therein.

The air having absorbed heat from the battery system 100 through the circulation duct 400 can be introduced into the outlet space 502.

The outlet 500 may send a portion of the air introduced into the outlet space 502 back to the interior space 10 of the vehicle 1, and may discharge the remaining portion of the air to the outside of the vehicle 1.

In detail, the outlet 500 can include a connection passage 504 connecting the outlet space 502 to the circulation duct 400, a main discharge port 510, and a branch discharge port, any of, any combination of, or all of which may be in plural or may include plural components thereof.

The connection passage 504 can be formed in the bottom surface of the outlet space 502 and can be connected to the circulation duct 400. The connection passage 504 can serve as a passage that guides air having passed through the circulation duct 400 to the outlet space 502.

The main discharge port 510 and the branch discharge port can be exits through which air introduced into the outlet space 502 is discharged. The main discharge port 510 can guide air to the outside of the vehicle 1, and the branch discharge port guides can guide air to the interior space 10.

The blower fan 600 can promote flow of air so that air sequentially flows along the inlet 300, the circulation duct 400, and the outlet 500. The blower fan 600 may be disposed in the air flow passage spanning the inlet 300, the circulation duct 400, or the outlet 500, or any combination thereof. The blower fan 600 can suction air from the inlet 300 and then discharge the air in one direction through the outlet 500.

The controller 800 may collect information about the temperature of the battery system 100, the temperature of each of the battery cells 110, the temperature inside the vehicle 1, and the temperature outside the vehicle 1, and may control, based on the collected information, the blower fan 600 and an air-conditioning device of the vehicle under preset conditions.

The device 200 for cooling the battery system 100 of the vehicle 1 according to an embodiment of the present disclosure may further include a heat exchange system 700.

The heat exchange system 700 may be located in the air flow passage spanning the inlet 300, the circulation duct 400, or the outlet 500, or any combination thereof. In more detail, the heat exchange system 700 may be mounted in the inlet 300 or the circulation duct 400.

The heat exchange system 700 can lower the temperature of the introduced air to a predetermined or selected temperature.

However, this is merely given by way of example. The inside air cooled through the air-conditioning device in the interior space 10 of the vehicle 1 may be used as air to be supplied to the circulation duct 400, and the heat exchange system 700 does not necessarily need to be provided or mounted.

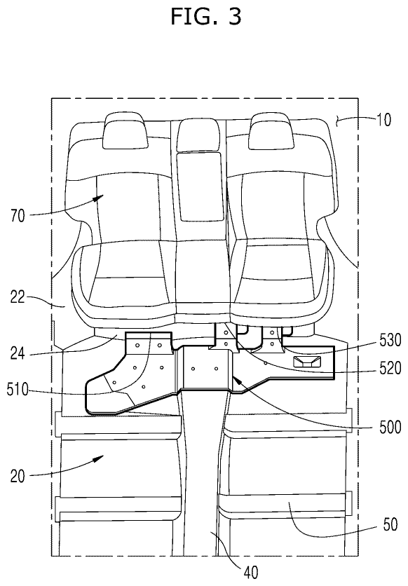

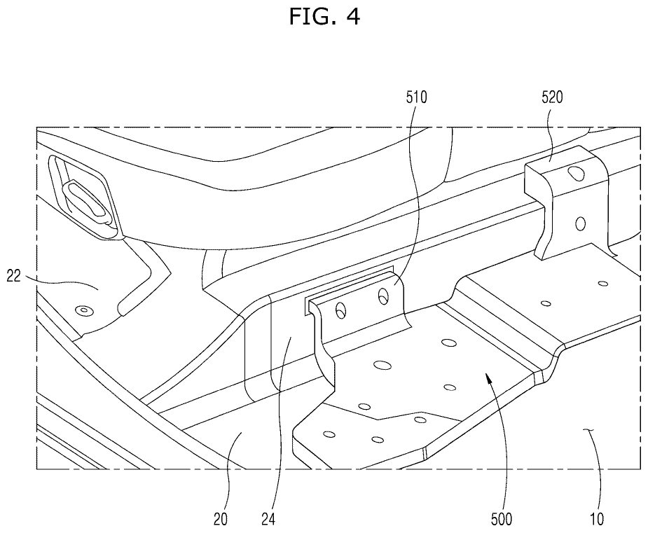

FIGS. 3 and 4 are views showing the interior space 10 of the vehicle 1 in which the device 200 for cooling the battery system 100 of the vehicle 1 according to an embodiment of the present disclosure is mounted.

As shown in FIGS. 3 and 4, the outlet 500 of the device 200 for cooling the battery system 100 according to an embodiment of the present disclosure may be mounted on a vehicle body floor 20, which can be a bottom surface of the vehicle 1.

The outlet 500 may be coupled to the upper surface of the vehicle body floor 20 in the interior space 10 of the vehicle 1. The outlet 500 may be formed to have a thin plate-like structure that widely spreads in the horizontal direction on the upper surface of the vehicle body floor 20. The outlet space 502 in which air flows can be defined in the outlet 500.

The structure of the vehicle body floor 20 may vary depending on the design of the vehicle 1. The vehicle body floor 20 may include a vehicle body transverse member 40 extending longitudinally along the driving direction of the vehicle 1, a vehicle body longitudinal member 50 formed to intersect the vehicle body transverse member 40, a raised portion 22 protruding upward, and a depressed portion formed downward.

Front seats, which correspond to a driver seat and a front passenger seat, can be mounted on a portion of the upper surface of the vehicle body floor 20, and rear seats 70 can be mounted behind the front seats located in the front row.

The outlet 500 may be manufactured to fit the shape of the surface of the vehicle body floor 20.

The outlet space 502 in the outlet 500, as a passage formed on the bottom surface, can include the connection passage 504 connected to the circulation duct 400.

The connection passage 504 may be formed at a position adjacent to a side surface of the outlet 500.

The main discharge port 510 and the branch discharge port, as passages connected to the outlet space 502, may extend upward from the outlet 500.

The main discharge port 510 can be formed at a position adjacent to the connection passage 504, and the branch discharge port can be formed next to the main discharge port 510.

The branch discharge port may be provided in plural, and the plurality of branch discharge ports may be divided into a first branch discharge port 520 and a second branch discharge port 530 in an order close to the connection passage 504 and the main discharge port 510, for example. Any number of branch discharge ports may be included in an embodiment.

The main discharge port 510 may be connected to the outside through a vertical wall 24 of the raised portion 22 of the vehicle body floor 20.

A main discharge passage 512 can extend from the interior space 10 of the vehicle 1 to the outside through the vehicle body floor 20, and the main discharge port 510 can be formed at an end of the main discharge passage 512.

Thus, the air discharged through the main discharge port 510 can be not returned to the interior of the vehicle and can be discharged outside.

As shown in FIGS. 3 and 4, the first branch discharge port 520 and the second branch discharge port 530 may be sequentially disposed at predetermined intervals from the main discharge port 510.

The first branch discharge port 520 and the second branch discharge port 530 can be formed at an end of a first branch discharge passage 522 and an end of a second branch discharge passage 532, respectively, which can be connected to the outlet space 502. The air discharged through the first and second branch discharge ports 520 and 530 can flow to the interior space 10.

The first branch discharge port 520 and the second branch discharge port 530 may be disposed so as to discharge air toward a space between the vehicle body floor 20 and the rear seats 70.

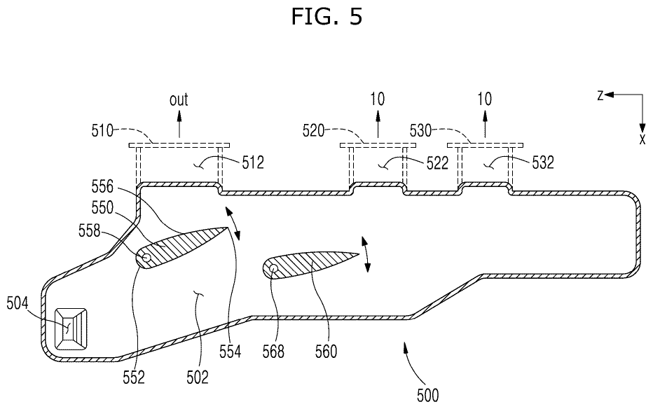

As shown in FIG. 5, the connection passage 504 can be formed in one side of the outlet 500, and the main discharge port 510 and the branch discharge ports 520, 530 can be sequentially formed in an order close to the connection passage 504.

In an embodiment of the present disclosure, the cross-sectional area of the main discharge passage 512 can be larger than the sum of the cross-sectional areas of the plurality of branch discharge passages 522, 532, and the cross-sectional area of the main discharge port 510 can be also larger than the sum of the cross-sectional areas of the plurality of branch discharge ports 520, 530. The reason for this can be to make the amount of air discharged outside larger than the amount of air recirculating to the interior of the vehicle, thereby preventing deterioration in air-conditioning efficiency of the interior space 10, for example.

The plurality of branch discharge passages and the plurality of branch discharge ports can be formed such that the cross-sectional areas thereof gradually decrease in a direction away from the connection passage 504 and the main discharge port 510. That is, the cross-sectional areas of the first branch discharge passage 522 and the first branch discharge port 520 can be larger than those of the second branch discharge passage 532 and the second branch discharge port 530, respectively. Similarly, the cross-sectional areas of the second branch discharge passage 532 and the second branch discharge port 530 can be larger than those of a third branch discharge passage and the third branch discharge port (if any), respectively.

Accordingly, the flow rate of air to the main discharge port 510 close to the connection passage 504 can be maximized, and the flow rates of air to the branch discharge ports can gradually decrease in a direction away from the connection passage 504, thereby reducing vibration and noise that may occur due to air discharged to the outlet 500.

A main flow guide 550 and an auxiliary flow guide 560 may be provided in the outlet space 502, which is the space defined in the outlet 500.

The main flow guide 550 and the auxiliary flow guide 560 may adjust the direction of air flowing through the outlet space 502.

The main flow guide 550 may be coupled to a control shaft 558. The control shaft 558 may extend across the outlet space 502 in an upward-downward direction and may be rotatable within a predetermined angular range, for example.

The main flow guide 550 may have a streamlined wing shape, and may be adjusted in angle by the control shaft 558. That is, the main flow guide 550 can include a leading edge 552 forming a gently curved surface in a direction facing the connection passage 504, a trailing edge 554, and two guide surfaces 556 interconnecting the leading edge 552 and the trailing edge 554 in a streamlined shape.

The main flow guide 550 may be disposed in the outlet space 502 at a position connected to the main discharge passage 512. The main flow guide 550 may guide air introduced through the connection passage 504 and may adjust the flow rate of air flowing to the main discharge passage 512.

The auxiliary flow guide 560 may be configured in the same form as the main flow guide 550, and may be mounted in the outlet space 502 at a position adjacent to one of, several of, or each of the branch discharge passages. The auxiliary flow guide 560 may be coupled to an auxiliary shaft 568, and may adjust the air flow direction in accordance with rotation of the auxiliary shaft 568.

The angles of the control shaft 558 and the auxiliary shaft 568 can be adjusted by the controller 800.

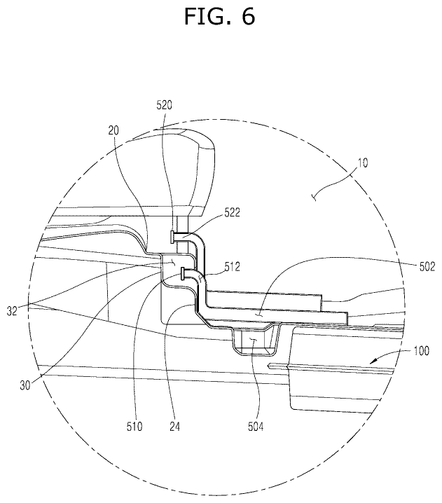

FIG. 6 is a longitudinal-sectional view of the device 200 for cooling the battery system 100 of the vehicle 1 according to an embodiment of the present disclosure.

As shown in FIG. 6, the outlet 500 may be formed in a shape corresponding to the upper surface of the vehicle body floor 20 and may be mounted on the bottom surface of the interior space 10 of the vehicle 1.

The connection passage 504 connected to the outlet space 502 can be located under the outlet 500 and can guide air introduced thereinto via the circulation duct 400 to the outlet space 502. A portion of the introduced air can be discharged outside through the main discharge port 510, and the remaining portion of the introduced air can move to the interior space 10 through the branch discharge ports.

The main discharge port 510 may pass through the vertical wall 24, formed on the vehicle body floor 20, in the transverse direction and may protrude to the outside of the vehicle body. A discharge guide 30 may be further provided under the vehicle body floor 20. The discharge guide 30 can form a neutral passage 32 that protects the main discharge port 510 so that the main discharge port 510 is not directly exposed to the outside of the vehicle body.

Thus, the discharge guide 30 can cause air having passed through the main discharge port 510 to be discharged to the outside space via the neutral passage 32, thereby preventing water or foreign substances from entering the main discharge port 510.

As can be apparent from the above description, according to an embodiment of the present disclosure, flow resistance of circulating cooling air can be reduced, and thus airflow noise occurring in a duct can be greatly reduced.

According to the present disclosure, cooling air is allowed to smoothly flow along a circulation passage, with a result that energy loss is reduced, and cooling efficiency is improved.

According to an embodiment of the present disclosure, because a portion of circulating cooling air is discharged to the outside of a vehicle body, the maximum output of a blower fan can be lowered, and thus vibration and noise due to operation of the blower fan can be reduced.

According to an embodiment of the present disclosure, physical vibration applied to a duct can be reduced, with a result that the possibility of a device being damaged can be lowered, and the durability of the device can be improved.

The advantages achievable through an embodiment of the present disclosure are not necessarily limited to the above-mentioned advantages, and other advantages not mentioned herein can be understood by those skilled in the art from the above description.

The example embodiments of the present disclosure have been described above with reference to the accompanying drawings. However, the example embodiments are for illustrative purposes, and the present disclosure is not necessarily limited to the above-described example embodiments and the accompanying drawings. The scopes of the present disclosure can be defined by the technical spirit set forth in the appended claims.

Although not all actions or advantages according to the configurations of the example embodiments have been explicitly described, it can apparent that actions or advantages predictable from the configurations herein can also be recognized as falling within the spirit and scopes of the present disclosure.

What is claimed is:

1. A device for cooling a battery system of a vehicle, wherein the battery system is disposed below a vehicle body floor of the vehicle, and the device comprising:
an inlet having an inlet entrance configured to receive air introduced therein, the inlet being configured to allow the introduced air to flow to the battery system; and
an outlet comprising an outlet space defined therein, the outlet being configured to discharge air having passed through the inlet, the battery system, and the outlet space, wherein the outlet comprises:
a connection passage as an connection entrance configured to allow air having passed through the battery system to enter the outlet space,
a main discharge port as a first exit configured to discharge air from the outlet space to an outside of a vehicle body, and
a branch discharge port as a second exit configured to discharge air from the outlet space to an interior space of the vehicle body.

2. The device according to claim 1, further comprising:
a circulation duct enclosing the battery system and configured to form an air flow passage so that air introduced into the inlet exchanges heat with the battery system; and
a blower fan configured to cause air to flow along the inlet, the circulation duct, and the outlet.

3. The device according to claim 1, further comprising a heat exchange system configured to cool air received by the inlet to a selected temperature.

4. The device according to claim 1, wherein the inlet is configured to receive air from the interior space of the vehicle body.

5. The device according to claim 1, wherein the outlet is coupled to an upper side of the vehicle body floor provided on a bottom surface under the interior space of the vehicle body.

6. The device according to claim 5, wherein the main discharge port comprises a main discharge passage passing through the vehicle body floor in a transverse direction to form a floor discharge passage connected from the outlet space to outside of the vehicle body.

7. The device according to claim 5, wherein the branch discharge port comprises at least two branch discharge ports configured to discharge air from the outlet space to the interior space of the vehicle body.

8. The device according to claim 5, wherein the main discharge port is disposed closer to the connection passage than the branch discharge port.

9. The device according to claim 5, wherein a first cross-sectional area of a first passage interconnecting the main discharge port and the outlet space is larger than a second cross-sectional area of a second passage interconnecting the branch discharge port and the outlet space.

10. The device according to claim 5, wherein the outlet comprises at least one flow guide provided in the outlet space configured to adjust a flow direction of air inside the outlet.

11. The device according to claim 10, wherein each of the at least one flow guide comprises:
a leading edge facing the connection passage and formed as a curved surface;
a trailing edge with a thickness gradually decreasing in a direction opposite the leading edge; and
a pair of guide surfaces connecting the leading edge and the trailing edge, the pair of guide surfaces being formed as streamlined curved surfaces.

12. A device for cooling a battery system of a vehicle, the device comprising:
an inlet having an inlet entrance configured to receive air introduced therein, the inlet being configured to allow the introduced air to flow to the battery system; and
an outlet comprising an outlet space defined therein, the outlet being configured to discharge air having passed through the inlet, the battery system, and the outlet space, wherein the outlet comprises:
a connection passage configured to allow air having passed through the battery system to enter the outlet space,
a main discharge port configured to discharge air from the outlet space to an outside of a vehicle body, and
a branch discharge port configured to discharge air from the outlet space to an interior space of the vehicle body, wherein the main discharge port is disposed closer to the connection passage than the branch discharge port, and wherein a first cross-sectional area of a first passage interconnecting the main discharge port and the outlet space is larger than a second cross-sectional area of a second passage interconnecting the branch discharge port and the outlet space.

13. The device according to claim 12, further comprising:
a circulation duct enclosing the battery system and configured to form an air flow passage so that air introduced into the inlet exchanges heat with the battery system; and
a blower fan configured to cause air to flow along the inlet, the circulation duct, and the outlet.

14. The device according to claim 12, further comprising a heat exchange system configured to cool air received by the inlet to a selected temperature.

15. The device according to claim 12, wherein the inlet is configured to receive air from the interior space of the vehicle body.

16. The device according to claim 1, wherein the outlet is coupled to an upper side of the vehicle body floor provided on a bottom surface under the interior space of the vehicle body, wherein the main discharge port comprises a main discharge passage passing through the vehicle body floor in a transverse direction to form a floor discharge passage connected from the outlet space to outside of the vehicle body.

17. The device according to claim 12, wherein the branch discharge port comprises at least two branch discharge ports configured to discharge air from the outlet space to the interior space of the vehicle body.

18. The device according to claim 12, wherein the outlet comprises at least one flow guide provided in the outlet space configured to adjust a flow direction of air inside the outlet.

19. The device according to claim 18, wherein each of the at least one flow guide comprises:
a leading edge facing the connection passage and formed as a curved surface;
a trailing edge with a thickness gradually decreasing in a direction opposite the leading edge; and
a pair of guide surfaces connecting the leading edge and the trailing edge, the pair of guide surfaces being formed as streamlined curved surfaces.

20. A device for cooling a battery system of a vehicle, wherein the battery system is disposed below a vehicle body floor of the vehicle, and the device comprising:
an inlet having an inlet entrance configured to receive air introduced therein, the inlet being configured to allow the introduced air to flow to the battery system, wherein the inlet is configured to receive air from an interior space of a vehicle body;
an outlet comprising an outlet space defined therein, the outlet being configured to discharge air having passed through the inlet, the battery system, and the outlet space, wherein the outlet comprises:
a connection passage as an connection entrance configured to allow air having passed through the battery system to enter the outlet space,
a main discharge port as a first exit configured to discharge air from the outlet space to an outside of the vehicle body, wherein the main discharge port comprises a main discharge passage passing through the vehicle body floor in a transverse direction to form a floor discharge passage connected from the outlet space to outside of the vehicle body,
a branch discharge port as a second exit configured to discharge air from the outlet space to the interior space of the vehicle body, and
at least one flow guide provided in the outlet space configured to adjust a flow direction of air inside the outlet, wherein each of the at least one flow guide includes:
a leading edge facing the connection passage and formed as a curved surface,
a trailing edge with a thickness gradually decreasing in a direction opposite the leading edge, and
a pair of guide surfaces connecting the leading edge and the trailing edge, the pair of guide surfaces being formed as streamlined curved surfaces,
wherein the main discharge port is disposed closer to the connection passage than the branch discharge port,
wherein a first cross-sectional area of a first passage interconnecting the main discharge port and the outlet space is larger than a second cross-sectional area of a second passage interconnecting the branch discharge port and the outlet space,
wherein the outlet is coupled to an upper side of the vehicle body floor provided on a bottom surface under the interior space of the vehicle body;
a circulation duct enclosing the battery system and configured to form an air flow passage so that air introduced into the inlet exchanges heat with the battery system;
a blower fan configured to cause air to flow along the inlet, the circulation duct, and the outlet; and
a heat exchange system configured to cool air received by the inlet to a selected temperature.
